(19) United States
(12) Patent Application Publication
(10) Pub. No.: US 2003/0036376 A1
(43) Pub. Date: Feb. 20, 2003

(54) Method and system for wireless audio message delivery

(76) Inventors: David B. Annan, Oakville (CA); Eric K. Chan, Richmond (CA); Eddie S. DeCurtis, Southlake, TX (US); Teresa L. Stephens, Westport, CT (US); George L. Lasota, JR., New York, NY (US); William J. Schaefer, Charlemont, MA (US)

Correspondence Address: Merchant & Gould, PC, P.O. Box 2903, Minneapolis, MN, 55402-0903, US

(21) Appl. No.: 09/981,777

(22) Filed: Oct. 16, 2001

Related U.S. Application Data
(60) Provisional application No. 60/240,642, filed on Oct. 16, 2000.

(51) Int. Cl. H04M 11/00

(52) U.S. Cl. 455/406; 455/408

(57) ABSTRACT

A system and method for receiving and sending information content in audio form to a wireless communication device on demand. The system can be customized by a wireless communication device user to obtain the desired information content in audio form. The customization of the system reduces the amount of time necessary to obtain the desired information and thus the length of time of the communication is reduced.

This application claims the benefit of United States provisional patent application Ser. No. 60/240,642, filed on Oct. 16, 2000, entitled “A Method And System For Wireless Audio Message Delivery,” the disclosure of which is incorporated herein by reference.

### BACKGROUND OF THE INVENTION

Systems using Interactive Voice Response (“IVR”) technology have been present in the telecommunication marketplace since the late 1970's. IVR technology allows a user to establish a normal voice call and use a keypad to issue instructions to a receiving end. The receiving end then directs the conversion of the requested information into audio form to be presented to the telephone in the form of recorded messages.

IVR technology was extended to wireless communications in 1987 with the commercial introduction of wireless IVR information services. Rogers Cantel Incorporated's #123 Info and #STK StockTalk services were offered to Cantel subscribers and users were provided with user controlled traffic, weather, sports, and news items. These systems processed calls routed to adjunct equipment which presented audio content to the subscriber via the user's cellular telephone. Similar technology is currently used to control voicemail systems, customer service access lines, and automated banking applications. For instance, in the prior art IVR systems, a user accesses, for example, a voicemail system to retrieve messages. Specific codes (e.g., *4) can then be entered by the user to retrieve system created data (e.g., date/time of message or identity of caller).

These prior art services use the North American air link standard, which is commonly known as Advanced Mobile Phone System (“AMPS”) with the official designation ANSI 553, and the handset standard TIA IS-19. The handset standard TIA IS-19 has since been superseded by the audio sections of various digital handset standards.

With the advent of digital standards, an alternate signaling structure was created known as Digital Control Channel (“DCC”). The digital control channel was designed to carry data in addition to call control information (e.g., Setup, Teardown, Channel Assignment, Handoff, etc.) including Short Message Teleservices (“SMS” or Short Message Services) to and from the handsets over the digital control link established between a handset and a mobile switching office. In the 1980's and 1990's, three digital cellular standards emerged. The European Group Special Mobile (“GSM”), which was later renamed Global System for Mobility in English, devised a set of telesystem message delivery standards as well as a unique internetworking protocol called GSM MAP. The internetworking protocol allows communication between two or more communication networks. The two North American standards, TDMA (“TIA IS-136”) and CDMA (“TIA IS-95”) with associated handset standards both chose to utilize the same standard, TIA IS-41, to support internetworking operations. Both internetworking standards include Short Message Teleservices based upon the prior GSM specification of this messaging technique. Two-way or Mobile Originated SMS services are widely used in Europe to access local or global computer network content.

A number of firms have developed Short Message Based information services. The services utilize special dialing sequences (e.g., ##) as described in the TCAP messaging standards contained in IS-41. The special dialing sequences allow carriers to intercept dialed sequences which are outside the standard North American Numbering Plan (“NANP”). The GSM, NANP, and TCAP systems utilize the dial digits from the subscriber's handset to select the information for delivery to the user's handset using Short Message Teleservices defined under IS-41.

The wide scale adoption of standards based inter-carrier roaming capabilities for cellular and PCS carriers has created a digital control environment suitable to support local or global computer network based information services. While some vendors utilize the text message capabilities inherent in current cellular networks for ‘Push’ or ‘Event-Triggered’ services (e.g., a stock quote is sent to a user when the stock reaches a user specified price) and some offer customer controlled ‘pull’ audio services (e.g., a stock quote is sent to a user when requested by the user) using Dual Tone Multi-Frequency (“DTMF”) tone control over an established voice call to access audio menus with expensive long duration wireless calls to an IVR service, the system embodying the disclosed invention utilizes the inherent call routing and signaling capabilities contained in existing systems to automatically select the desired information and route the incoming information request call to an appropriate audio output.

One embodiment of the invention disclosed herein combines both existing techniques and utilizes dial digit triggers to re-route a subscriber's call as well as selecting the desired audio information content for playback once the call is delivered to the content provider's server. In this way the content provider can deliver audio output to any analog or digital cellular or wireless telephone which is operating under an IS-41 or GSM MAP standard.

This invention also utilizes System Signaling 7 (“SS7”) links for carrying IS-41c internetworking communications traffic and may also use SS7 ISUP links for delivering calls to the content provider's server. The SS7 system is a digital data network carrying signaling information which interfaces with the carriers' specialized internetwork signaling network.

### BRIEF DESCRIPTION OF THE DRAWINGS

The objects, features, and advantages of the present invention will be apparent from the following detailed description of the invention, which is to be read in connection with the accompanying drawings in which:

FIG. 1 is an illustration of a transaction flow diagram in accordance with one embodiment of the invention;

FIG. 2 is a pictorial diagram of an I/O processing overview in accordance with one embodiment of the invention; and

FIG. 3 is a pictorial diagram of communication facilities in accordance with one embodiment of the invention.

FIG. 4 is a pictorial diagram of a web site page used to customize an embodiment of the wireless audio message delivery system.

FIG. 5 is a pictorial diagram of a web site page used to customize an embodiment of the wireless audio message delivery system.

### DESCRIPTION OF THE INVENTION

The invention disclosed covers a system which offers the carrier the capability of utilizing an existing SS7 system to provide their customers with the capability to access a local or global computer network and enhanced information capabilities directly via their digital and analog wireless cellular and PCS telephones. In this way, the duration, and thus the cost, of long distance and local cellular and PCS telephone calls are reduced.

One aspect of the invention offers a completely self-contained customer self-configuration interface as well as digit trigger processing and output management facility. The invention utilizes its own or existing audio delivery technology based upon existing Interactive Voice Response (IVR) equipment to manage the audio delivery of content for the services while assuring a manageable performance environment and maintaining the response latency to acceptable levels.

Another aspect of this invention is to deliver content for all existing cellular and PCS telephones on carrier networks and all future telephones with voice call capability. A system embodying the invention may be selected as a delivery option in a telecommunications service provider's computer network or other access portal or can be provided as a delivery service to other information portals. In virtually all cases, the subscriber will be charged for the use of airtime for the information delivery since the service requires the use of a ‘voice’ channel of the carrier to deliver the audio. The call duration, however, is minimized to the targeted content selection being completed by the signaling network. Call duration is minimized by using the user's preset information codes instead of working through a series of menus to specify the desired information.

In operation, a user subscribes to a content provider service and is given access to a content provider web site. The user then accesses the web site and sets preferences for the type of information (e.g., sports scores, local weather, or traffic reports) the user wishes to retrieve in audio format. The user will also set the access codes that will be used to request the specified preferences (e.g., “##1” would be entered to retrieve the score of the New York Yankees baseball game and “##2” would be entered to retrieve the present days weather forecast for New York City). The user then dials the access code on the wireless device (e.g., “##2” and “SEND”). A signal containing the information request and the location of the wireless device is transmitted to the carrier as part of a normal call setup procedure. The signal is then transmitted to the content provider via an SS7 system (i.e., TCAP (ORREQ) message). The content provider verifies the user authorization to access the system and retrieves the user preferences (i e., if ##2 is dialed by the user, the system knows the specific user desire the weather forecast for New York City). The information content (i.e., the weather forecast for New York City) corresponding to the user preferences is then retrieved from a local or global computer network. The information content is then transmitted to an audio delivery system. The user's telephone is re-routed to the audio delivery system (i e., TCAP orreq return result) over the Public Switched Telephone Network (ie., PSTN) and the information content is transmitted in audio form to the user.

In order to provide audio services to all current service carriers, the system utilizes the ability of Mobile Telephone Switching Offices (“MTSO”) or Mobile Switching Centers (“MSC”) to process dialed digit strings outside the normal telephone number pattern to support user-controlled ‘Pull’ services. All the popular brands of switches support the required finctionality. Since most carriers support either IS-41 or GSM MAP based TCAP services, a system may use supplementary dial digit string analysis capabilities of these systems to provide the common user input.

A service subscriber is provided a default web configuration facility providing services configuration and instructions on the use of the services. Popular local or global computer network-connected browsers are used to modify, add, and delete available services. The customer is also given instructions regarding the updating of the appropriate mobile telephone address book to allow the customer to access the services without remembering the customer assigned dial trigger codes (i. e., “##xxxx”). The dial trigger codes are preset by the user the specify the desired information.

Using the local or global computer network browser, the customer may subscribe to additional services including extra cost or premium services. The extra cost or premium services may include services which establish temporary dial digit trigger responses to support limited customer interactivity.

The user configures the system by accessing a web site, selecting user preferences, and setting preferred access codes. Once configured, the customer may manually dial or utilize the address book to dial the appropriate code with a “##” prefix followed by {SEND}. The use of the prefix was chosen so as not to interfere with any widely used numbering convention within the network. The MSC processes the code, the call is re-routed and the customer call is automatically answered followed by the audio playback of the requested information. The audio output is created from audio stream files such as WAV or MP3 file types as well as direct text to speech conversion by the audio delivery facility. The content provider thereby offers the customer a simple, self-managed approach to obtaining local or global computer network content on the existing voice capable telephone.

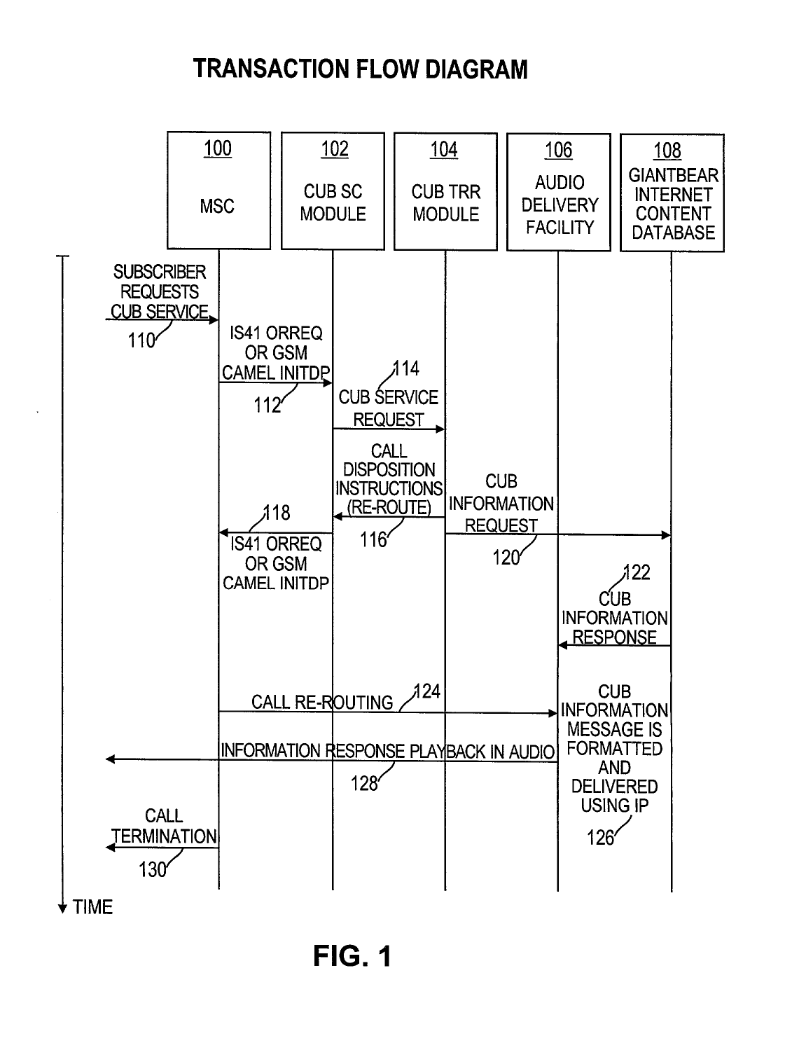

An embodiment of the present invention is illustrated in FIG. 1. FIG. 1 is a Transaction Flow Diagram which illustrates the sequence of events for wireless audio message delivery. Time increases from the top of the page to the bottom of the page. For example, subscriber request CUB service 110 occurs first and call termination 130 occurs last. Somewhere between those two events, CUB information request 120 occurs. Mobile Switching Center (“MSC”) 100 controls call routing and includes wireless telephone software. In operation, a wireless telephone user requests CUB service 110 (i.e., the user depresses #, #, code) and is connected to MSC 100. Upon receiving the request, MSC 100 parks the call and generates an origination request 112. MSC 100 then transmits the origination request 112 to CUB service control module 102. The CUB service control module 102 is software which runs on the SS7 System. The CUB service control module 102 then generates a CUB service request 114 which is transmitted to CUB TCAP return result (“TRR”) module 104. The CUB TRR module 104 cross references the identity of the caller with the individuals code key (i.e., the user customizes a set of codes to correspond to specific information). For example, if the wireless telephone user had entered #, #, 123, it could mean the score of a baseball game or the local weather depending on the user's preset codes. The CUB TRR module 104 also generates the rerouting instructions 116. The CUB TRR module 104 then transmits the re-routing instructions 116 to the CUB SC module 102. The CUB SC module 102 then generates an origination request return result 118 that is transmitted to MSC 100. The origination request return result 118 includes re-routing instructions for MSC 100. CUB TRR module 104 also transmits the CUB information request 120 to the GiantBear Internet Content Database 108. The GiantBear Internet Content Database 108 is capable of retrieving desired information from a local or global computer network and also storing popular information resident in its memory. The GiantBear Internet Content Database 108 retrieves the requested information and transmits the CUB information response 122 to the Audio Delivery Facility 106. The Audio Delivery Facility 106 temporarily stores the information response until a connection to re-routed call 124 is made. When the re-routed call 124 arrives at the Audio Delivery Facility 106, it is automatically answered. The Audio Delivery Facility 106 uses known caller ID methods to identify the rerouted call 124 and match it with the information response. When re-routed call 124 connects to the Audio Delivery Facility 106 the information response 122 is transmitted as an audio response 128 to the cellular telephone user. The call is then terminated 130.

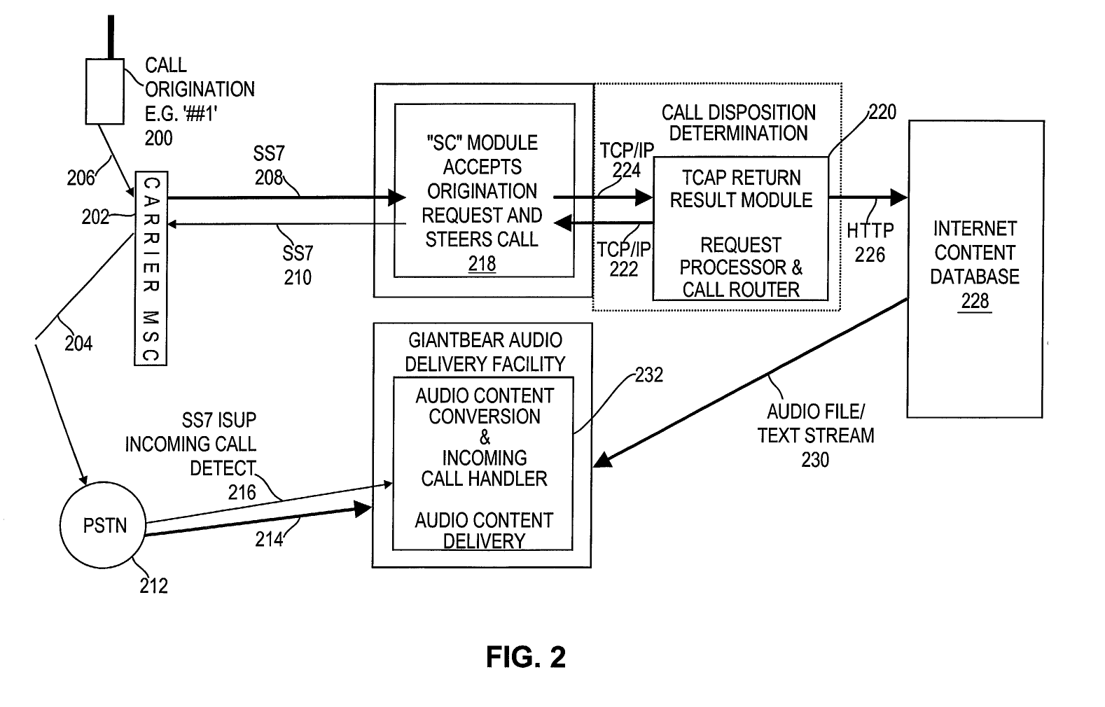

FIG. 2 illustrates the physical connections between the system components. A cellular telephone originates a call 200 by dialing #, #, code. The #, #, code signal is then transmitted via connection 206 which is typically the airwaves. The carrier MSC 202 receives the #, #, code signal and generates an origination request 208 which is transmitted to SC module 218. SC module 218 transmits the origination request via connection 224 to the TCAP return results module 220. The TCAP return results module 220 cross references the user identification and user code key to determine what information is requested and also generates re-routing instructions. The re-routing instructions are transmitted via connection 222 to the SC module 218. SC module 218 then transmits the re-routing instructions via connection 210 to the carrier MSC 202. The carrier MSC 202 then transmits the re-routing instructions to PSTN 212 via connection 204. The TCAP return result module 220 generates the information request and transmits the information request via connection 226 to the GiantBear internet content database 228. The GiantBear internet content database 228 retrieves the requested information and transmits it in audio form via connection 230 to audio content conversion and incoming call handler 232. The audio content conversion and incoming call handler 232 also receives the rerouted call via connection 214. The audio content conversion and incoming call handler 232 then transmits the requested information in audio form to the cellular telephone user.

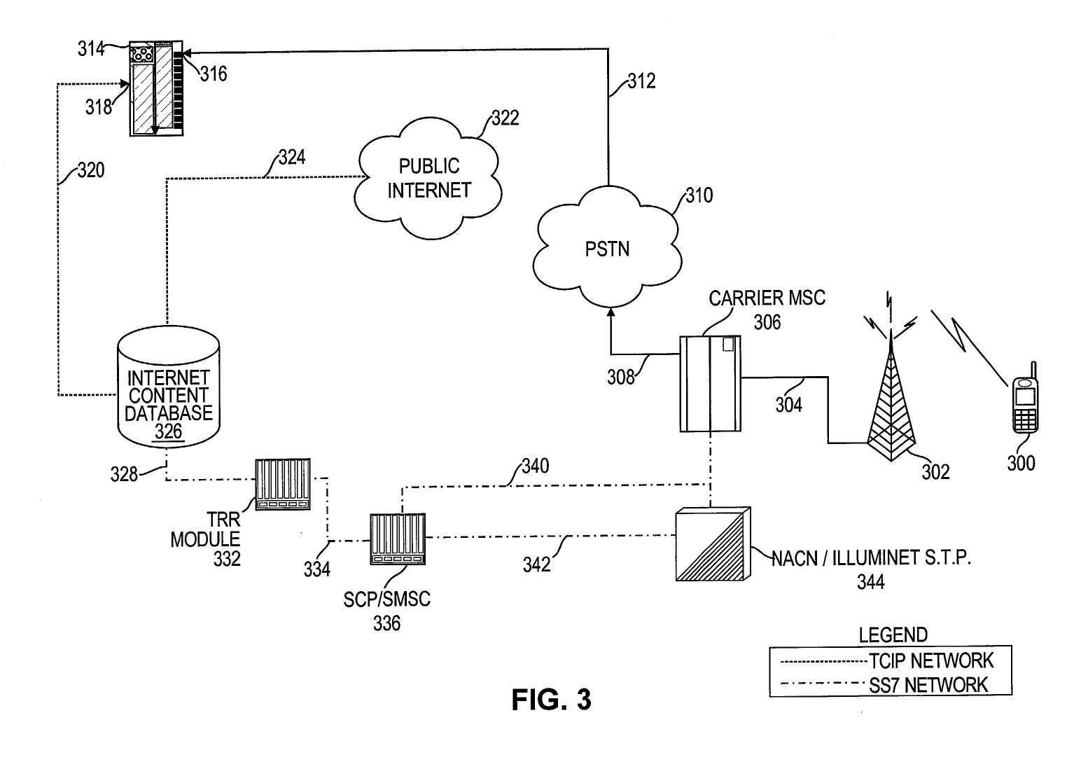

FIG. 3 is another embodiment of the system connections of the system components. Cellular telephone 300 initiates a user's request by dialing #, #, code then the request is transmitted to cellular antenna 302 which is electrically connected to carrier MSC 306 via connection 304. An origination request is generated and transmitted over connection 340 to SCP/SMSC module 336. The request is then generated from SCP/SMSC module 336 to TRR module 332 via connection 334. The TRR module 332 determines what information has been requested and the re-routing instructions. The re-routing instructions are transmitted back to the SCP/SMSC 336 which in turn transmits the re-routing instructions to NACN/Illuminet S.T.P. 344 via connection 342. The NACN/Illuminet S.T.P. 344 then transmits the re-routing instructions to carrier MSC 306. The carrier MSC 306 then re-routes the call via connection 308 to PSTN 310. PSTN 310 then transmits the call via connection 312 to audio delivery facility 314. The TRR module 332 generates an information request to the GiantBear Internet Content Database 326 via connection 328. The information response is then transmitted by the GiantBear Internet Content Database 326 to the audio delivery facility 314 via connection 320. When the audio delivery facility has received the information response and has been connected to the re-routed call, the information response is transmitted in audio form to the cellular telephone user.

One embodiment of the invention offers a broad selection of local or global computer network-based content information for the benefit of its customers. Examples of some of the types of information which the system may provide include the following: national headline news, local weather forecasts, severe weather alerts, national sports news and scores, stock portfolio quotes, horoscopes, lottery results, mobile yellow pages, movie schedules, local headline news, local dining, emergency services, local lodging, local sports, airline schedules and ticketing, joke of the day, and community calendar. This list is provided for illustrative purposes only and does not represent a limitation on the capabilities of this invention. All content offered by the content provider's service is at the carrier's discretion and the content provider works with client carriers to incorporate content to support the carrier's marketing approach.

In order to activate a customer on the system, the carrier may forward a content provider a specified provisioning message or file for bulk ordering. The message or file may contain information on the mobile telephone MIN (Mobile Identification Number), a pricing plan option, and various optional fields designed to support the carrier branded product implementation. The activation messages or files can be sent using an encrypted SMTP message (“SSL”) to the content provider's firewall protected provisioning local or global computer network gateway. Other provisioning facilities can be utilized to meet the carrier's specification.

The content provider's system is based on wireless Information Network (“IN”) architecture which allows wireless users to access local or global computer network information on their digital cellular or PCS telephones by dialing unique abbreviated service codes (e.g., ‘##1’ and ‘##2’).

The system is designed to be ‘carrier grade’ in terms of quality and reliability to ensure the carrier of reliable delivery performance as markets grow rapidly. The software architecture is implemented upon distributed, scalable and high-availability technology. The system utilizes multiple distributed servers to process wireless interactive information service requests and transactions. The servers are connected via a TCP/IP LAN/WAN arrangement located in the content provider's service bureaus.

The carrier's SS7 server would maintain identifying information of a carrier on the NACN or Illuminet SS7 interconnected networks (i.e., destination point code, subsystem number, etc.) and process IS-41 Origination Request messages from carrier MSC's, extract the relevant fields (e.g., MIN, dialed information request digits, and wireless device location) and generate an information query to the content provider's customer database server. In operation, the user dials the access code on the wireless device and then call setup functions cause a signal containing the MIN, information request digits, and wireless device location to be transmitted to the carrier MSC (i.e., ORREQ). The signal is then routed to the carrier's SS7 server and the three pieces of data are then transmitted to the content provider. The carrier receives the response return result from the content provider's output manager via the SS7 TCAP (orreq) protocol interface and the originating MSC then manages the routing of a voice call to the appropriate audio delivery facility to provide audio delivery to the voice capable mobile telephone.

A customer database server “dips” (i.e., accesses) the carrier's customer database to interpret the dialed digit string to produce a query to the content provider's local or global computer network database. This server also maintains the customer database through the customer provisioning interface as well as event logging for transaction billing capabilities.

An audio delivery facility receives the information request packages from the customer database server and manages the handling of the incoming call using ISUP SS7 signaling to identify and match the incoming originating number to assure transmission of the audio response to the appropriate customer.

All SS7 functionality is based upon systems designed, implemented and installed by a major vendor of SS7 equipment with systems running on the current NACN/Illuminet network with equipment supporting the required SS7 SCP functionality. The equipment utilized is a subset specification of the equipment described in standards such as Home Location Register (“HLR”) with functionality to interpret and coordinate Origination_Request_Invoke (ORREQ) and Origination_Request_Return Result (orreq) messages The following represents a detailed description of the sequence of events in one embodiment that the content provider uses to process customer-originated information requests:

The customer configures a wireless access to an information content field using a web browser on the local or global computer network and then enters a numeric access code up to 20 digits in open input boxes appearing after the “##” prefix to access the system. (The system provides a set of carrier default information services and associated access codes are pre-established by the system.) Once submitted, the changes update the subscriber profile on the content provider's system.

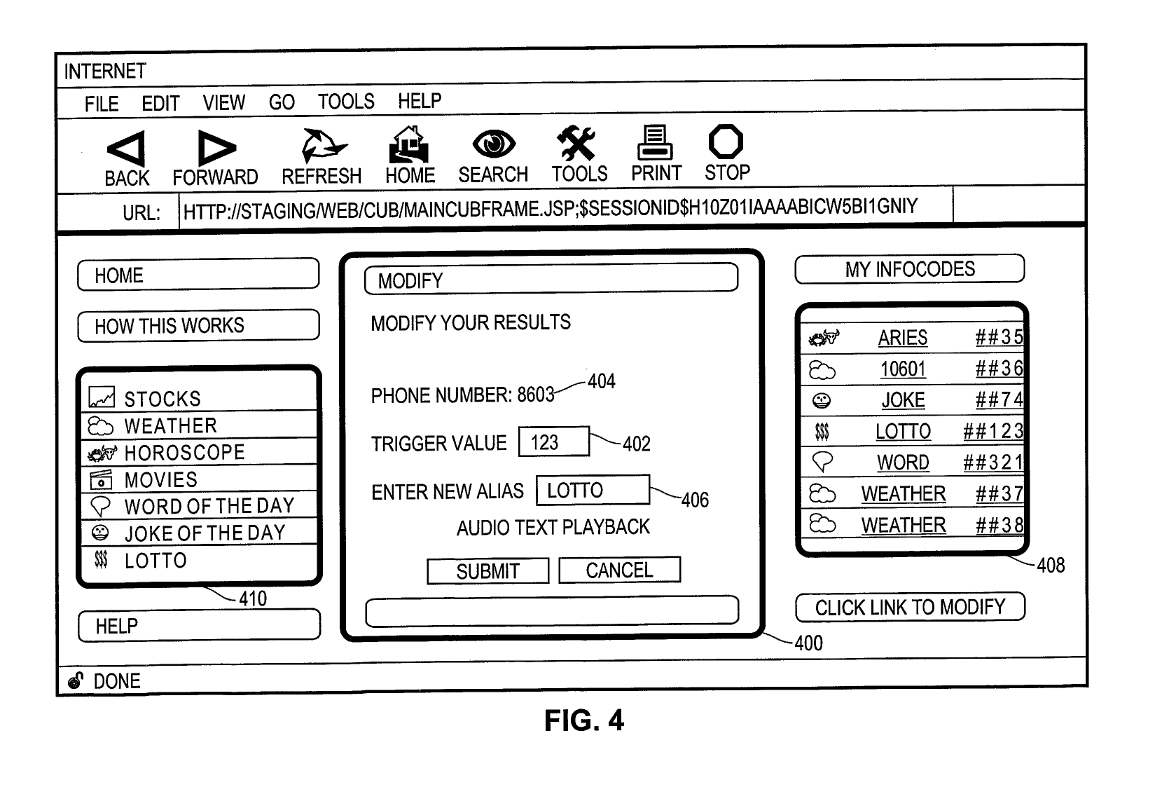

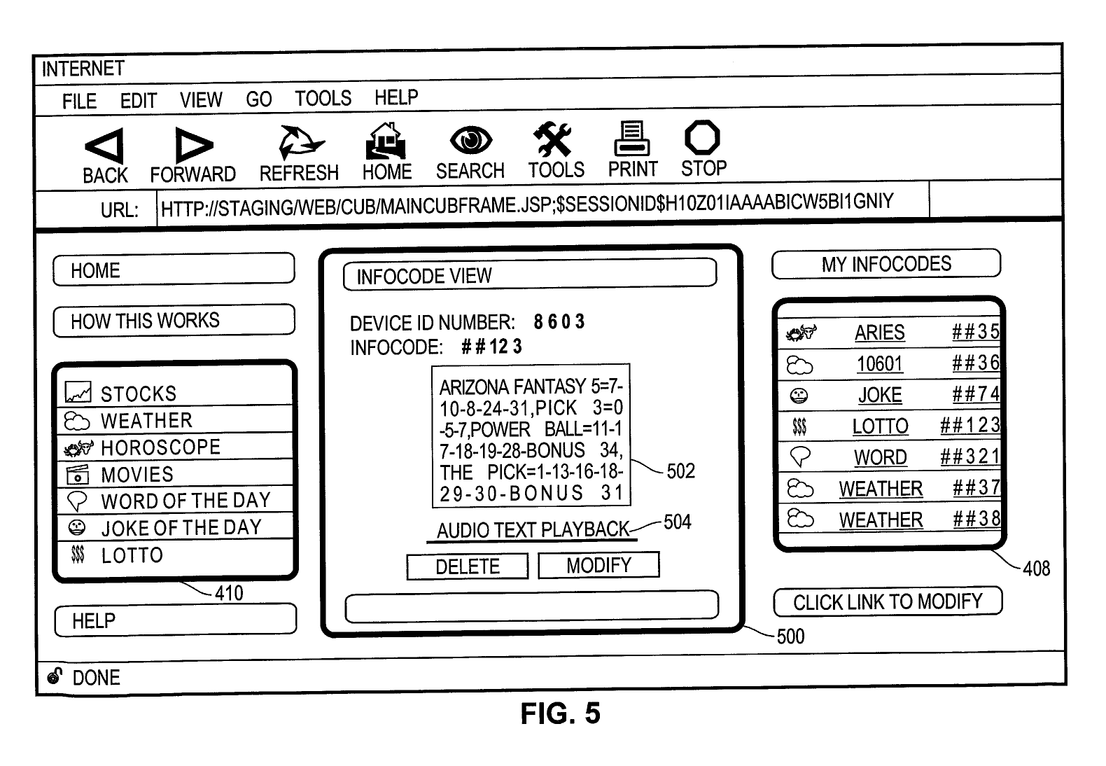

FIGS. 4 and 5 illustrate the web site pages on which the customized codes may be preset by the user. In FIG. 4, modify window 400 allows a user to set the trigger value (i.e., the code for specific information) 402, the user mobile telephone number 404, and the textual description of the information (i.e., alias) 406. The user's customized code list (“My Infocodes”) 408 contains a list of the textual descriptions of the information 406 and the trigger value 402. To modify an entry in the customized code list 408, a user simply clicks on the textual description of the information 406 and then modifies the information in the modify window 400.

The user can also select information to be placed in the user's customized code list 408 by selecting categories in the information category window 410. After selecting the category (e.g., stocks), the user can drill down in the category until the desired information is specified (e.g., the ticker symbol for IBM to obtain stock quotes). A trigger value 402 and a textual description 406 for the specific information are then selected by the user in the modify window 400.

The results can be confirmed by using the infocode view window 500 as illustrated in FIG. 5. The infocode view window 500 allows the user to select the specific information and have it displayed in display window 502 or have it played in audio form 504 over the computer system. Using the features illustrated in FIGS. 4 and 5, a user can select desired information, customize a list of desired information, and confirm that the listed links will, in fact, obtain the desired information.

A wireless device, for example, a mobile telephone, is then used to dial an information access code (i. e., ‘##123’) to access the service information field assigned to ‘123.’ The user then depresses the {Send} key on the telephone to transmit the access code to the content provider.

The serving MSC analyzes the dialed data sent during the access request from the mobile telephone and determines that the origination trigger is active. The MSC sends an SS7 IS-41c Origination_Request_Invoke message to the carrier's SS7 server SCP on the NACN/Illuminet network at the assigned Illuminet Destination Point Code (“DPC/SSN”) activated by the dialed digit trigger function of the MSC.

The carrier's SS7 server receives the Origination Request (ORREQ), and parses the message for the MIN, dialed digit string and originating MSCID. The carrier's SS7 server then constructs and transmits a valid origination request response (orreq) to the originating MSC to either drop the call or re-route to a recorded announcement on the serving MSC.

In one embodiment, the content provider is capable of recognizing an invalid call attempt when a caller attempting to access the system is not identified as a subscriber. A “Subscriber Not Activated” indication results on the content provider's system. In response, the content provider's system SCP decodes the TCAP message, transmits an orreq response ordering call disconnect and logs the error to the content provider's alert database. The call, which had been parked, is then routed to a fast busy tone or specific recorded announcement at the originating switch.

Another way that the content provider is capable of recognizing an invalid call attempt is when a valid caller sends an invalid digit trigger. When this occurs, the content provider's system SCP responds as described for a valid call and the content provider's system routes the call normally to the audio delivery facility which responds with an audio message indicating “Invalid Information Request Dialed.”

The carrier's SS7 server then sends the query information to the content provider's customer database server which authenticates the customer's service rights and the subscriber device descriptor by the MIN as well as the information service specified by the dialed digits. The content provider's customer database server then constructs an HTTP query to the content provider's local or global computer network database for the required content.

If the call is re-routed to a remote audio delivery facility, the content provider's local or global computer network database then transmits the MIN, device descriptor, and current output content to the carrier's audio delivery facility. This output manager then queues the output and awaits the appearance of an incoming customer call from the requesting customer. Once a call is received, the call is answered, the content played and the call disconnected.

In one embodiment, the invention includes the following features:

a) The MSC supports Origination Request Trigger on a subscriber basis. A unique prefix is used for the trigger (e.g., “##” since it is not in common usage);

b) The carrier supports IS-41c call origination trigger capabilities and is connected to the SS7 network for automatic roaming;

c) The carrier administration group has local or global computer network connectivity to support provisioning and customer accounting activities;

d) Subscribers have ANSI 553 analog, IS-54B, IS-136, IS-95, GSM or other similar digital mobile telephones;

e) SS7 links are dimensioned based upon customer traffic and anticipated usage patterns between the carrier's MSC facilities and the SS7 network;

f) The carrier updates dialed digit translations to accommodate the required dialed digit triggers;

g) The carrier opens SS7 firewall access barriers in order to contact the content provider's system on the SS7 network and accept the content provider originated SS7 TCAP messages; and

h) The carrier's SS7 network equipment is updated to recognize the content provider's systems as a valid destination point code.

The methods for delivering wireless audio messages may be implemented in either software or hardware.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A method of retrieving information content wherein the method comprises the steps of:
configuring a system by assigning access codes;
communicating the access code and a mobile identification number from an originator to an information content provider using call setup information;
determining and transmitting the information content; and
receiving the information content from the information content provider.

2. The method of claim 1 wherein the step of configuring a system which contains information content comprises the steps of:
contacting an information content provider;
selecting desired information options; and
assigning an access code to the information option.

3. The method of claim 2 wherein the step of contacting the information content provider comprises the steps of:
obtaining access authorization from the information content provider and accessing an information content provider terminal through a local and global computer network.

4. The method of claim 1 wherein the step of communicating an access code to an information content provider comprises the steps of:
entering the access code into a communication device and electronically transmitting the access code to the information content provider.

5. The method of claim 4 wherein the step of electronically transmitting the access code to the information provider comprises the steps of:
transmitting the access code and mobile identification number to a mobile switching center; and
the mobile switching center:
receiving the access code and mobile identification number;
identifying transmission originator identification;
determining the location of the originator; and
transmitting the access code, the originator identification, and the location of the originator to the information content provider.

6. The method of claim 5 wherein the mobile switching center transmits to the information content provider through an SS7 network.

7. The method of claim 1 wherein the step of determining and transmitting the information requested comprises the steps of:
receiving the access code from a mobile switching center;
processing the access code;
retrieving the information associated with the access code;
converting the information associated with the access code into audible speech; and
transmitting the converted audible speech through a telephone network.

8. The method of claim 1 wherein the step of receiving information from an information content provider comprises the steps of:
transmitting audible information content requested by an originator through a public switch telephone network;
receiving the audible information content by a mobile switching center; and
transmitting the audible information from the mobile switching center to an originator.

9. The method of claim 8 wherein the step of receiving the audible information content by a mobile switching center comprises the steps of:
receiving a telephone call from the information content provider through a public switch telephone network;
receiving and processing originator information; and
receiving the audible information content.

10. The method of claim 9 wherein the step of receiving and processing originator information comprises the steps of:
receiving an originator mobile identification number;
receiving originator location information;
receiving dialing instructions from the internet content provider; and
preparing the audible information for wireless transmission to the originator.

11. A method of delivering information content from an information content provider wherein the method comprises the steps of:
designating information option codes;
receiving the option codes and transmission origination information through a wireless transmission without the prior establishment of a voice-grade connection;
locating the originator of the wireless transmission; and
transmitting the information content to the originator.

12. The method of claim 11 wherein the step of designating information option codes comprises the steps of:
accessing the information content provider through a local or global computer network;
selecting the option codes which correspond to desired information from a menu; and
assigning new option codes to the desired information as preferred.

13. The method of claim 11 wherein the step of receiving the option codes and transmission origination information through a wireless transmission comprises the steps of:
establishing a service control point for receiving and processing transmission information transmitted through an SS7 network;
receiving the service control information through messages through the SS7 network; and
processing the message to identify and locate the originator of the wireless transmission.

14. The method of claim 11 wherein the step of locating the originator of the wireless transmission comprises the steps of:
receiving the transmission origination information through an SS7 network;
processing the transmission origination information; and
calculating the most direct network route from the information content provider to the transmission originator location.

15. The method of claim 14 wherein the step of processing the transmission origination information comprises the steps of:
receiving a mobile information number associated with the transmission originator;
verifying access authorization for the originator using the mobile information number; and
retrieving a telephone number associated with the originator mobile information number.

16. The method of claim 15 wherein the step of transmitting the information content to the originator comprises the steps of:
retrieving the information associated with the option codes;
dialing the telephone number associated with the originator mobile information number; and
transmitting the information associated with the option codes to originator.

17. The method of claim 16 wherein the step of transmitting the information associated with the option codes comprises the steps of:
converting the information to audible speech information;
initiating a telephone call to the telephone number;
transmitting the audible speech information through a public switch telephone network; and
disengaging the telephone call when the information has been transmitted.

18. A system for delivering information using a wireless telephone network comprising:
means for configuring a system wherein desired information corresponds to a selectable code;
a first receiving and transmitting means for wireless transmission of said selectable code to a second wireless signal receiving and transmitting means;
said second wireless signal receiving and transmitting means for receiving said selectable code and transmitting said selectable code to a wireless signal switching means; and
said wireless signal switching means for receiving said selectable code from said second transmission means and transmitting said selectable code to said information provider,
wherein said information provider transmits the desired information corresponding to said selectable code to the first receiving and transmitting means.

19. The system of claim 18 wherein said wireless signal switching means is a mobile switching center.

20. The system of claim 19 wherein said first receiving and transmitting means is a mobile telephone.

21. A system for delivering information using a wireless telephone network comprising:
means for configuring a system wherein desired information corresponds to a selectable code;
a first receiving and transmitting means for wireless transmission of a signal corresponding to said selectable code to a signal receiving and transmitting site;
a second wireless means for receiving said selectable code signal and transmitting said selectable code signal to a wireless signal switching means; said wireless signal switching means for receiving said selectable code signal from said second transmission means and transmitting said selectable code to a wireless-nonwireless interface; said wireless-nonwireless interface capable of receiving said wireless selectable code signal and converting said wireless selectable code signal to a nonwireless selectable code signal and transmitting said nonwireless signal through a nonwireless network to said information provider,
wherein said information provider transmits the desired information corresponding to said selectable code to the first receiving and transmitting means.

22. The system of claim 21 wherein said nonwireless network is a TCP/IP network.

23. The system of claim 22 wherein said wireless signal switching means is a mobile switching center.

24. The system of claim 23 wherein said first receiving and transmitting means is a mobile telephone.

25. The system of claim 20 wherein said nonwireless network is an SS7 network.

26. The system of claim 25 wherein said wireless signal switching means is a mobile switching center

27. The system of claim 26 wherein said first receiving and transmitting means is a mobile telephone.
